(19) United States
(12) Patent Application Publication
(10) Pub. No.: US 2022/0407863 A1
(43) Pub. Date: Dec. 22, 2022

(54) COMPUTER SECURITY USING ACTIVITY AND CONTENT SEGREGATION

(71) Applicant: Microsoft Technology Licensing, LLC, Redmond, WA (US)

(72) Inventors: Idan Y. Hen, Tel Aviv (IL); Itay ARGOETY, Redmond, WA (US); Idan BELAIEV, Redmond, WA (US)

(21) Appl. No.: 17/349,258

(22) Filed: Jun. 16, 2021

(51) Int. Cl. H04L 29/06; G06K 9/62

(52) U.S. Cl. CPC H04L 63/104; H04L 63/102; H04L 63/20; G06K 9/6215

(57) ABSTRACT

Generally discussed herein are devices, systems, and methods for improving computer resource security. A method can include receiving a computer activity log detailing activities of users in a computer network. The method can include identifying activities of the activities in the computer activity log that include a specified user identification (ID) value. The method can include mapping each of the identified activities to a predicate group of predicate groups and a subject group of subject groups. The method can include generating a behavior profile for a user associated with the user ID, the behavior profile including, for each activity the predicate group and the subject group to which the activity mapped in place of a description and action of the activity. The method can include based on the generated behavior profile, monitoring the computer network for malicious activity.

### BACKGROUND

To help identify potentially malicious actions on a computer network, a model of user behavior can be generated. This model is sometimes called a user behavior profile. One way to determine whether a user behavior is a potentially malicious action is to learn behaviors that are similar, such as by a heuristic model. The heuristic model can. include manmade rules that define which behaviors are similar.

Determining which behaviors are similar is a. time consuming manual process. A person, such as a subject matter expert, that classifies behaviors as similar can analyze two behavior descriptions and either relate the two behaviors as similar or dissimilar. This requires the subject matter expert to understand the description of the behavior, which is often not very descriptive or requires detailed knowledge of the inner workings of a network and how activities are logged.

What is desired is a solution for relating behaviors as similar without requiring detailed knowledge of the description of the behavior and consumes less human time, Embodiments provide such a solution.

### SUMMARY

A method, device, or machine-readable medium for cloud resource security management can improve upon prior techniques for cloud resource security management. The method, device, or machine-readable medium can simplify a behavior profile of a user in a. time and compute bandwidth efficient manner. The method, device, or machine-readable medium can receive or retrieve a definition of subject groups and predicate groups. The definition can include words associated with the respective subject groups and predicate groups. The method, device, or machine-readable medium can map activities in a compute resource activity log to a corresponding subject group and a corresponding predicate group based on token/word similarity of the activity and the definitions of the respective subject: groups and predicate groups. A user behavior profile can then be created that includes the subject group and the predicate group to which an activity maps in place of the activity.

The method, device, or machine-readable medium can perform operations including receiving a computer activity log detailing activities of users in a computer network, the computer activity log including one or more of a resource management log or a resource operation log. The operations can further include identifying activities of the activities in the computer activity log that include a specified user identification (ID) value. The operations can further include mapping each of the identified activities to a predicate group of predicate groups and a subject group of subject groups. The operations can further include generating a behavior profile for a user associated with the user ID, the behavior profile including, for each activity the predicate group and the subject group to which the activity mapped in place of a description and action of the activity. The operations can further include based on the generated behavior profile, monitoring the computer network for malicious activity.

The operations can further include receiving a second computer activity log detailing further user activity of the user associated with the specified user ID value in the computer network. The operations can further include mapping the further user activity to a same or different predicate group and a same or different subject group. The operations can further include, based on the same or different predicate group and subject group, determining whether the further user activity is consistent with the generated behavior profile. The operations can further include providing an alert responsive to determining the further user activity is not consistent with the generated behavior profile.

Mapping the further user activity to a same or different predicate group and subject group can include determining a similarity between tokens and words of the further user activity and predicate seed words associated with each predicate group, respectively. Mapping the further user activity to a same or different predicate group and subject group can include associating the further user activity with the predicate group determined to be most similar to the further user activity. Mapping the further user activity to a same or different predicate group and subject group can include determining a similarity between tokens and words of the further user activity and the seed words associated with each subject group, respectively. Mapping the further user activity to a same or different predicate group and subject group can further include associating the further user activity with the subject group determined to be most similar to the further user activity.

The operations can further include associating, with each of the predicate groups, predicate seed words. The operations can further include projecting the predicate seed words, respectively, and tokens and words of activities, respectively, to an embedding space. The operations can further include associating a token of the tokens with a predicate group of the predicate groups if the token is within a specified distance of a predicate seed word associated with the predicate group resulting in an expanded word set for the predicate group.

The operations can further include associating, with each of the subject groups, subject seed words. The operations can further include projecting the subject seed words, respectively, to the embedding space. The operations can further include associating a token of the tokens with a subject group of the subject groups if the token is within a specified distance of a subject seed word associated with the subject group, resulting in an expanded word set for the subject group. Mapping each of the identified activities to a predicate group of predicate groups and a subject group of subject groups can be performed based on the expanded word set for the subject group and the expanded word set for the predicate group.

### BRIEF DESCRIPTION OF DRAWINGS

FIG. 1 illustrates, by way of example, a diagram of an embodiment of a computer system.

FIG. 2 illustrates, by way of example, a block diagram of an embodiment of a system for behavior profile generalization.

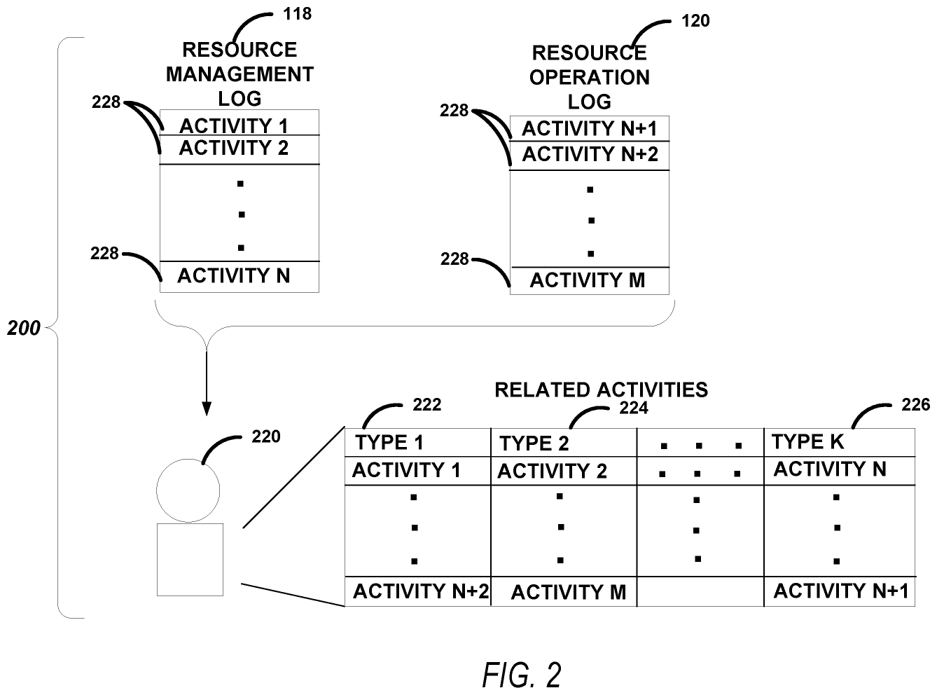

FIG. 3 illustrates, by way of example, a block diagram of an embodiment of a system for improved generation of behavior profiles.

FIG. 4 illustrates, by way of example, a diagram of an embodiment of a process for generating a behavior profile.

FIG. 5 illustrates, by way of example, a diagram of an embodiment of a system for detecting anomalous behavior in a computer network, such as the network of FIG. 1.

FIG. 6 illustrates, by way of example, a block diagram of an embodiment of a method for compute resource security management.

FIG. 7 illustrates, by way of example, a block diagram of an embodiment of a machine (e.g., a computer system) to implement one or more embodiments.

### DETAILED DESCRIPTION

In the following description, reference is made to the accompanying drawings that form a part hereof, and in which is shown by way of illustration specific embodiments which may he practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

Manual generalization of user behavior on a computer network by classification of activities can include a lot of manual work by domain experts. Such generalization is thus expensive, time consuming, and does not scale well. Embodiments provide a solution for computer resource security that includes some initial setup work, but is scalable and sufficiently flexible to handle new computer activities over time.

To effectively profile behavior of a user based on the different activities they perform, one can generalize common types of activities by grouping the common types of activities. The activities can be generalized such that similar actions are grouped together to create a baseline of activities. As the various types of activities may add up to an overwhelming amount—manual classification can be unmanageable.

Activities can be described as a combination of an activity type (a predicate) and activity content (a subject). The predicate can be considered as a more general aspect of the activity—such as reading (data), deleting (data), executing (a command), manipulating (data), and so on. The subject describes on what type of data the activity is being performed. For example—accounts, security software, network activity, etc.

The predicates can be grouped and the subjects can be grouped, such as by using a natural language processing (NLP) technique. Each of the activities can then be mapped to a group of predicates and a group of subjects. The group of subjects and the group of predicates to which the activity is mapped can then be used in place of the more specific action and description of the activity in a user behavior profile. By grouping activities according to these two characteristics, one can generalize behavior of a user while not oversimplifying the different activities. This information is helpful to profile the user activity over time and detect attack patterns or kill chains.

Using an NLP based technique for grouping of the subjects and predicates can provide an automatic grouping of different activities. Different activities that map to a same predicate group and subject group pair can be considered the same activity. Since NLP can make a determination of the subject and predicate group pair to which an activity maps based on the textual description provided to each activity embodiments can offer an automated solution to an otherwise complex issue that was previously accomplished. manually.

Embodiments can include performing two classification tasks for activities, such as to group activities. The first classification task can include classifying activities based on the activity predicate (read, write, delete, obfuscate (e.g., encrypt or the like), etc.), and the second is classifying activities based on the activity subject (security software, network, etc.).

Each activity can comprise an (action, description) pair. For example, the activity “Microsoft.Network/azurefirewalls/read-Get Azure Firewall” can be represented by the (action, description) pair (MicrosoftNetwork/azurefirewalls/read, Get Azure Firewall). Embodiments can determine the activity predicate is “retrieving data” and the activity subject is “security software” for this example activity.

For each of the first and second classification tasks, a set of one or more seed words can be defined for each predicate group and subject matter group, such as by a subject matter expert (SME) or other personnel. These seed words can be determined based on samples from a dataset comprising example activities. More relevant keywords for a given group can be determined using a word embedding that is generated based on security data (one can either train such embedding or use one of many publicly available ones).

In an example, the following activities all have the same activity predicate of retrieve:
1. Microsoft.KeyVault/vaults/secrets/getSecret/action—Gets the value of a secret.

2. Microsoft.Network/azurefirewalls/read—Get Azure Firewall.
3. Microsoft.ClassicStorage/images/read—Returns the image.
4. Sql/managedInstances/administrators/read—Gets a list of managed instance administrators.

These activities can be mapped to a same predicate group using seed words such as: (get, read, list). Using word embeddings, the seed word list can be expanded. A distance between a lemma of each word in the activities can be used identify words sufficiently related to each seed word (in the embedding space). For example, the lemmatized version of “returns” (found in sample 3) is “return”, and its embedding is close to the embedding of the seed word “get” This identification of further related words can be run periodically, such as to handle new activities.

The same process can be The following activities all have the same activity subject—Security Software:
1. Microsoft.Network/azurefirewalls/read—Get Azure Firewall.
2. Microsoft.Network/azurefirewalls/delete—Delete Azure Firewall
3. Microsoft.Sql/managedInstances/databases/vulnerabilityAssessments/rules/baselines/write—Change the vulnerability assessment rule baseline for a given database
4. Microsoft.Authorization/policyAssignments/read—Get information about a policy assignment.

The subject group can be identified by mapping each activity to a subject group that includes seed words such as: (Firewall, vulnerability, policy). This seed word list can be expanded using word embeddings in a similar manner as discussed regarding the predicate group. For example, the word “rule” (found in sample 3) is close to the seed word “policy” in the embedding space, so it can be added as a seed word for the “Security Software” content type.

The extended seed word lists for each predicate group, subject group pair can be used to categorize a next activity, to classify the activities, by using term frequency-inverse document frequency (TF-IDF) or word similarity between words or symbols in a given activity and the seed word list.

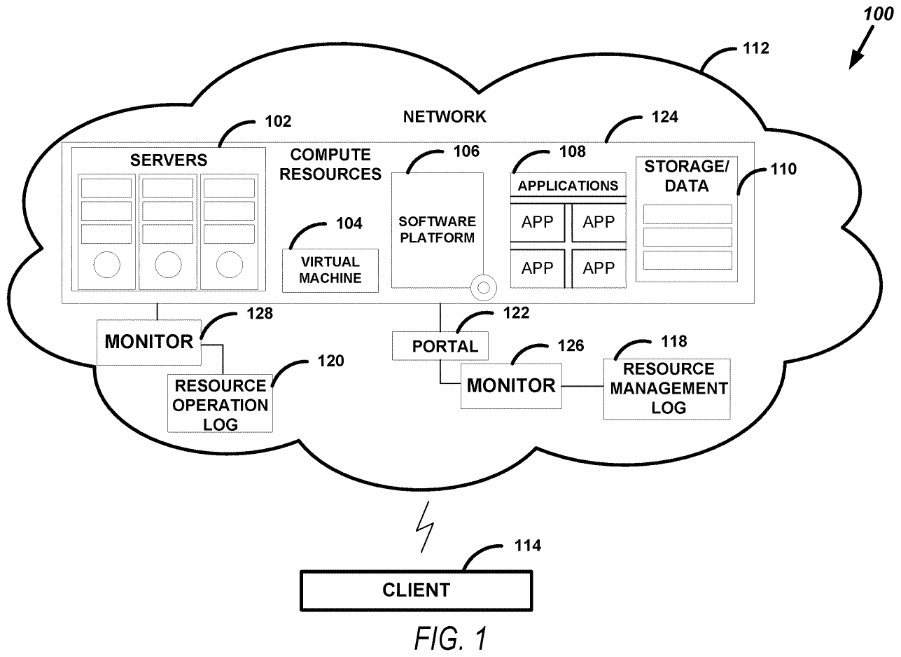

FIG. 1 illustrates, by way of example, a diagram of an embodiment of a computer system 100. The computer system 100 can provide computing services to various computing systems such as desktops, laptops, tablets, smartphones, embedded computers, point-of-sale terminals, and so on. The computer system 100 can include compute resources that includes for example, servers and storage devices as well as various software products such as operating systems, databases, and applications.

The computer system 100 as illustrated includes a client 114 communicating with a network 112 of compute resources 124. The network 112 can provide services of a data center. Many enterprises (cloud customers) can subscribe as customers of a database service of the computer system 100 to store and process their data. For example, a retail company can subscribe to a database service to store records of the sales transactions of the company and use an interface provided by the database service to run queries to help in analyzing the sales data. As another example, a utility company can subscribe to a database service for storing meter readings collected from the meters of its customers. As yet another example, a government entity can subscribe to a database service for storing and analyzing tax return data of millions of taxpayers.

Enterprises that subscribe to or access the network 112 want data privacy and security assurances. Although the network 112 can employ many techniques to help preserve the privacy of customer data, parties seeking to steal such data are continually devising new techniques to access the data.

The network 112 is a network of servers and other computer resources that are accessible through the Internet and provides a variety of hardware and software services. These resources are designed to either store and manage data (e.g., storage/data 110), run applications 108, or deliver content or a service (e.g., through servers 102). Services can include streaming videos, web mail, office productivity software, or social media, among others. Instead of accessing files and data from a local or personal computer, cloud data is accessed online from an Internet-capable device, such as a client 114.

The network 112 includes computing resources 124 which the client 114 can access for their own computing needs. The computing resources 124 as illustrated include servers 102, virtual machines 104, software platform 106, applications 108, and storage/data 110.

A user of the client 114 can access resources 124 of the network 112. To access the resources 124, the user can log into a portal 122. Logging into the portal 122 can include providing a username, password, two-factor authentication, or the like. The user can then access or generate one or more of the resources 124, move one or more of the resources 124, connect one or more resources 124 to each other, alter an access or security policy for one or more resources 124, or the like.

As the user performs tasks in the portal 122, a monitor 126 can generate entries in a resource management log 118, The monitor 126 can include software, hardware, firmware, or a combination thereof. The entries in the resource management log 118 can include at least some of the following information: (i) a user identification (ID) that uniquely identifies the user that was logged in to the portal 122 to perform a management operation on the resources 124, (ii) a resource ID that uniquely identifies the resource 124 that is a target of an operation performed by the user associated with the user ID (e.g., a uniform resource identifier (URI) or the like), (iii) an operation performed by the user associated with the user ID and on the resource associated with the resource ID, or (iv) a time at which the user associated with the user ID performed the operation on the resource associated with the resource ID. The entries can be organized in a table such that entries across a row or column can correspond to a same event, called an “action” herein. An example resource management log is provided:

TABLE 1
Example Resource Management Log

| User ID | ResourceID | Operation | Time | Day |
|---|---|---|---|---|
| Newton | Database1 | Connect server | 17:59 | Weds |
| | | to VM | | |
| Maxwell | Server8 | Install app | 9:17 | Mon |
| Bohr | Database4 | Create | 1:17 | Sat |

Table 1 is simplified to aid in understanding of the subject matter described. Typically, the resource management log 118 includes more than 3 actions. The resource management log 118 includes all operations performed from the portal 122 on the resources 124. With hundreds of users, the resource management log 118 can get quite large.

The resource operation log 12( )regards operations by the resources 124 while the resource management log 118 details operations for management of the resources 124 (sometimes called operations performed on the resources 124). The resource operation log 120 records operations of the cloud resource 124 (e.g., memory reads, memory writes, app to app communications, application execution, or the like). The resource management log 118 records operations performed in the portal 122 initiated by a user (e.g., database 110 generation, connecting resources 124, deploying an app 108, deleting or generating a virtual machine 104, or the like). A security measure provided based on the resource operation log 120, provides endpoint protection. In the example of the network 112, the endpoint is the resource 124. The security measures provided by endpoint protection can be different from the security measures provided based on the resource management log 118. The endpoint protection detects whether a particular resource 124 is attacked.

The servers 102 can provide results as a result of a request for computation, The server 102 can be a file server that provides a file in response to a request for a file, a web server that provides a web page in response to a request for website access, an electronic mail server (email. server) that provides contents of an email in response to a request, a login server that provides an indication of whether a username, password, or other authentication data are proper in response to a verification request.

The virtual machine (VM) 104 is an emulation of a computer system. The VM 104 provides the functionality of a physical computer. VMs can include system Vi is that provide the functionality to execute an entire operating system (OS) or process VMs that execute a computer application in an isolated, platform-independent environment. VMs can be more secure than a physical computer as an attack on the VM is merely an attack on an emulation. VMs can provide functionality of first platform (e.g., Linux, Windows, or another OS) on a second, different platform,

The software platform 106 is an environment in which a piece of software is executed. The software platform 106 can include hardware, OS, a web browser and associated application programming interfaces (APIs), or the like. The software platform 106 can provide tools for developing more computer resources, such as software. The software platform 106 can provide low-level functionality for a software developer.

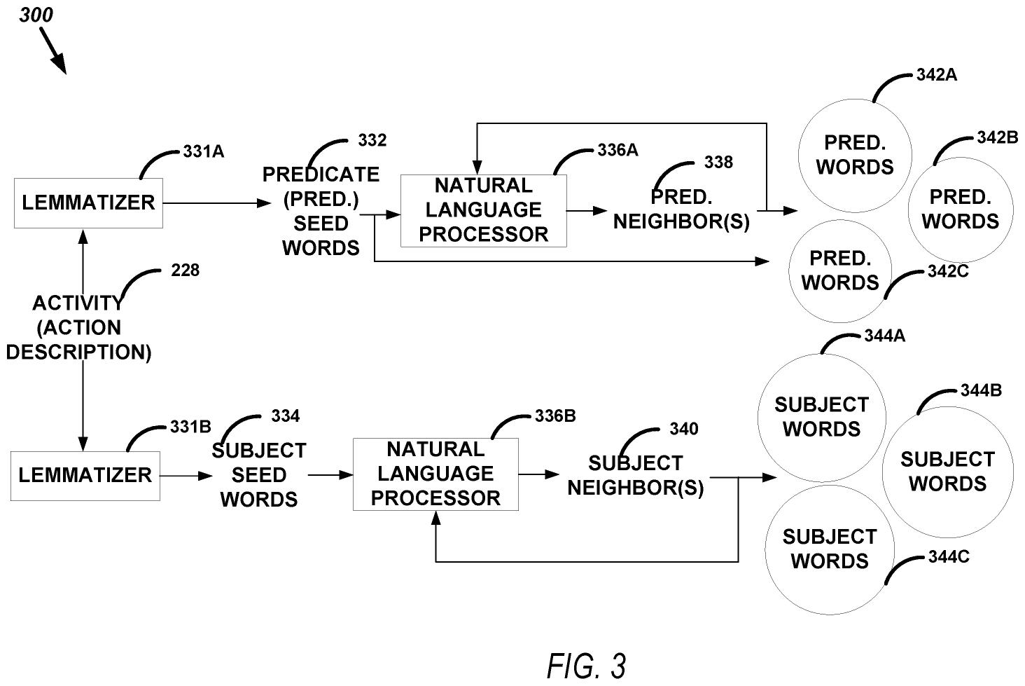

The applications 108 can be accessible through one of the servers 102, the VM 104, a container (see FIG. 3), or the like. The applications 108 provide compute resources to a user such that the user does not have to download or execute the application on their own computer. The applications 108, for example, can include a machine learning (ML) suite that provides configured or configurable ML software. The ML software can include artificial intelligence type software, such as a neural network (NN) or other technique. The ML or AI techniques can. have memory or processor bandwidth requirements that are prohibitively expensive or complicated for some cloud customers to implement or support.

The storage/data 110 can include one or more databases, containers, or the like, for memory access. The storage/data 110 can be partitioned such that a. given user has dedicated memory space. A service level agreement (SLA) generally defines an amount of uptime, downtime, maximum or minimum lag in accessing the data, or the like.

The client 114 is a compute device capable of accessing the functionality of the network 112. The client 114 can include a smart phone, tablet, laptop, desktop, a server, television or other smart appliance, a vehicle (e.g., a manned or unmanned vehicle), or the like. The client 114 accesses the resources provided by the network 112. Each request from the client 114 can be associated with an internet protocol (IP) address identifying the client 114, a username identifying a user of the device, a customer identification indicating an entity that has permission to access the network 112, or the like.

The network 112 is accessible by any client 114 with sufficient permission. Usually a customer will pay for or be provided with permission to access the network 112 using the client. Since multiple services and multiple clients 114 with different habits can access the network 112, it is difficult to provide a “one size fits all” security solution. Typically, an attack on the server 102 is different than an attack on the VM 104, which is different than an attack on a container, etc. These different attack vectors are usually handled by instantiating different security techniques with monitoring at each device, such as by the monitor 128. Also, these attack vectors can be related, as an attack on a container can be triggered by an impersonation attack, which can be detected by identifying an increase in failed login attempts or abnormal usage of a resource of the network 112 (relative to the user permitted to access).

In identifying an attack, an entity can analyze the resource operation log 120, the resource management log 118, or a combination thereof. The attack, in some instances, can he determined by comparing a user profile with entries of the resource operation log 120, the resource management log 118, or a combination thereof that include the specific user 1D as an entry. Activities that include the user ID as an are considered activities associated with the user ID.

FIG, 2 illustrates, by way of example, a block diagram of an embodiment of a system 200 for behavior profile generalization. The system 200 as illustrated includes an entity, such as a subject matter expert (SME) 220, manually organizing activities 228 from the resource management log 118 and the resource operation log 120 into types 222, 224, 226. As new activities 228 are discovered or generated, the SME 220 either adds a new activity type or adds the new activity to a corresponding type 222, 224, 226. This manual classification of activities into types is subjective as it relies on the opinion and action of the SME 220 to relate each activity 228 with a defined type 222, 224, 226 or a new type. The number of unique activities 228 can be quite large, even in a smaller network, thus making it quite difficult to be consistent and repeatable in the classification of the activity 228 to a type 222, 224, 226.

A user behavior profile can then be generated. The user behavior profile can include each activity associated with the user ID of the user mapped to one of the types 222, 224, 226 and aggregated, This profile can form a baseline understanding of the normal activity of the user in the network 112. The user behavior profile can then be used to identify whether future activity of the user in the network 112 are consistent with the behavior profile. If the future activity is consistent, as determined by some measure (discussed elsewhere), the activity is considered non-malicious. If the future activity is not consistent with the user behavior profile, the activity is considered malicious.

FIG. 3 illustrates, by way of example, a block diagram of an embodiment of a system 300 for improved generation of behavior profiles. The system 300 as illustrated includes an activity description 330 as input and. categories of predicate words 342A, 342B, 342C and categories of subject words 344A, 344B, and 344C as output.

The activity 228 can include an action and a description. Example actions in the context of cloud computing services provided by Microsoft® Corporation of Redmond, Wash., United States include:

1. Microsoft.KeyVault/vaults/secrets/getSecret/action

2. Microsoft.Network/azurefirewalls/read

3. Microsoft.ClassicStorage/images/read

4. Sql/managed/instances/administrators/read

5. Microsoft.Network/azurefirewalls/delete

6. Microsoft.Sql/managedInstances/databases/vulnerabilityAssessments/rules/baselines/write

7. Microsoft.Authorization/policyAssignments/read

The description of the activity 228 can include a natural language explanation of the activity 228. Example descriptions for each of the example actions provided above can be as follows, respectively:

1. Gets the value of a secret

2. Get Azure Firewall

3. Returns the image

4. Gets a list of managed instance administrators

5. Delete Azure Firewall

6. Change the vulnerability assessment rule baseline for a given database

7. Get information about a policy assignment

A lemmatizer 331A, 331B can extract a lemma of a predicate of the activity 228. A predicate is a part of a sentence or clause containing a verb and stating something about a subject. Examples predicates in the previously provided example activity actions and activity descriptions include “read”, “write”, “delete”, “gets”, “returns”, and “change”. The lemmatizer 331A, 331B provides the singular (non-plural), uninflected form of the word(s) provided thereto. For example, a lemma of the word “returns” is “return” and a lemma of the word “gets” is “get”.

Predicate seed word(s) 332 can be extracted from the activity 228. The predicate seed word(s) 332 can be augmented by personnel. The predicate seed word(s) 332 can be deemed related by the personnel. Similarly, subject seed word(s) 334 can be extracted from the activity 228. The subject seed word(s) 334 can be augmented by personnel. The subject seed word(s) 334 can be deemed related by the personnel.

The natural language processor 336A can project, individually, each of the predicate seed words 332 to an embedding space. The natural language processor 336B can project, individually, each of the subject seed words 334 to the embedding space. In the embedding space, words that are grammatically similar can be situated closer to one another. That is, the embeddings of words that are more similar in meaning tend to be closer to each other in the embedding space. Techniques for generating the word embeddings, which can be implemented by the natural language processor 336A, 336B can include Word2Vec, global vectors (GloVe), Flair, ELMo, bidirectional encoder representations from transformers (BERT), fastText, Gensim, Indra, and Deeplearning4j, among others.

The natural language processor 336A can identify any words in the embedding space that are close to any of the representations of the predicate seed words 332 in the embedding space. The natural language processor 336B can identify any words in the embedding space that are close to any of the representations of the subject seed words 334 in the embedding space. Embedding representations being close can mean (i) that a Euclidean, Manhattan or other distance metric satisfies a. first criterion (e.g., is less than a specified threshold) or (ii) a cosine or other similarity satisfies a second. criterion (e.g., is greater than a specified threshold).

The words with representations in the embedding space that are considered close to the representations of the predicate seed words 332 are called predicate neighbors 338. The predicate neighbors 338 can be processed by the natural language processor 336A to determine further predicate neighbors. A respective group of predicate words 342A, 342B, 342C can be defined for a given group of related predicate seed words 332, corresponding predicate neighbors 338, and optionally further predicate neighbors. In some instances, the predicate neighbors 338 can be a null set. In such instances, the predicate seed words 332 can be used as the group of predicate words 342A-342C.

The groups of predicate words 342A-342C can be used to categorize the activities 228. Any activity including one of the words in the group of predicate words 342A-342C can be mapped to the group of predicate words 342A-342C. Example groups of predicate words include {read, get, list} and {write, modify, change}.

The words with representations in the embedding space that are considered close to the representations of the subject seed words 334 are called subject neighbors 340. The subject neighbors 340 can be processed by the natural language processor 336B to determine further subject neighbors. A respective group of subject words 344A, 344B, 344C can be defined for a given group of related subject seed words 334, corresponding subject neighbors 340, and optionally further subject neighbors. In some instances, the subject neighbors 340 can he a null set. In such instances, the subject seed words 334 can be used as the group of subject words 344A-344C.

The subject group 344A-344C can be used to categorize the activity 228. Any activity 228 including one of the words in the group of subject words 344A-344C can be mapped to the group of subject words 344A-344C. An example group of subject words include {firewall, vulnerability, policy}.

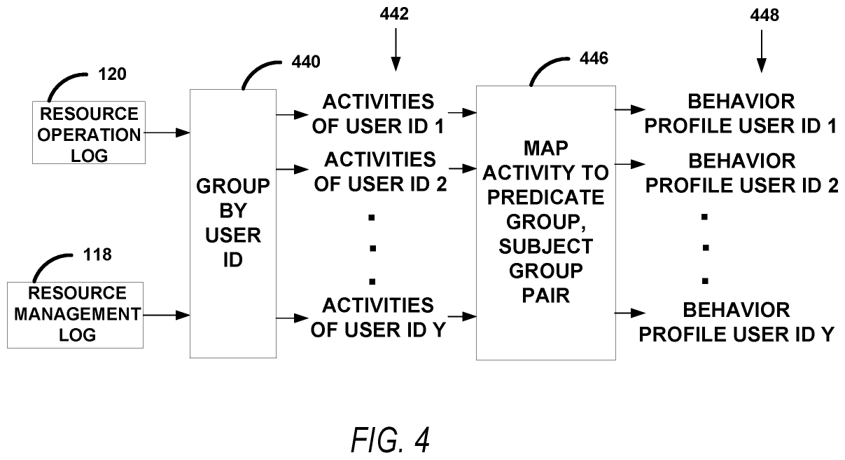

Using the system 300, the activity 228 can be mapped to a pair comprising a group of predicate words 342A-342C and a group of subject words 344A-344C, The pair to which the activity 228 is mapped can then represent the activity in a behavior profile, FIG. 4 regards generation of the behavior profile,

FIG. 4 illustrates, by way of example, a diagram of an embodiment of a process 400 for generating a behavior profile 448. The process 400 as illustrated. includes receiving or retrieving the resource operation log 120, resource management log 118, or a combination thereof. At operation 440, activities 228 in the resource operation log 120 or resource management log 118 are grouped by user ID. Each entry in the resource operation log 120 or the resource management log 118 can include a user IT) field that uniquely identifies a user that caused the activity to be performed. The operation 440 can include identifying the activities 228 that include a same user ID in the user ID field. The identified activities 228 that are associated with the same user ID are activities of user ID X 442.

Each of the activities of user ID X 442 can be mapped to a predicate group 342A-342C and subject group 344A-344C group pair at operation 446. Each activity 228 can thus be represented by time predicate group 342A-342C and subject group 344A-344C group pair and optionally along with some additional information, The additional information can include a date, time, or the like, that is unique to the activity and is detrimental to generalize further.

The operation 446 can include determining a similarity between words or tokens of the activity and a given predicate group, subject group pair. A token, as used herein, is a set of characters before or after a pre-defined special symbol, For example, in example 6 above, namely
“Microsoft.Sql/managedInstances/databases/vulnerabilityAssessments/rules/baselines/write”, each of “Microsoft.Sql” “managedInstances” “databases” “vulnerabilityAssessments” “rules” “baselines” and “write” are considered tokens and “/” is the pre-defined special symbol. Other special symbols exist and are typically not numeric or letter symbols. Similarity can be measured by distance in embedding space, cosine similarity, term frequency-inverse document frequency (TF-IDF) or some other measure of similarity,

The result of the process 400 is a behavior profile 448 associated with each user 1D. The behavior profile 448 is generalized at the activity level, but is still specific to the user as it can include dates, times, activities, or a combination thereof that are performed by the user.

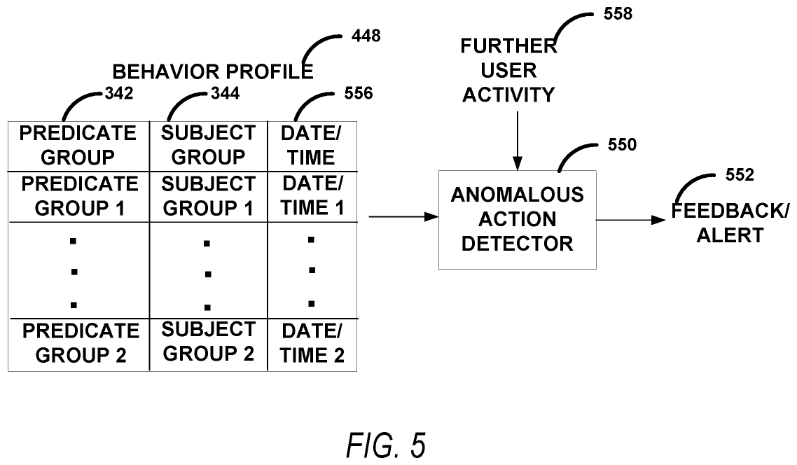

FIG. 5 illustrates, by way of example, a diagram of an embodiment of a. system 500 for detecting anomalous behavior in a computer network, such as the network 112. The system 500 as illustrated includes an anomalous action detector 550 that receives the behavior profile 448 and (if applicable) generates feedback/alert 552. The behavior profile 448 as illustrated includes a predicate group 342, a subject group 344 and date/time 556 at about which the activity mapped to the predicate group 342 and subject group 344 pair was performed or detected.

The anomalous action detector 550 can receive or retrieve further user activity 558 and receive or retrieve the behavior profile 448. The anomalous action detector 550 can compare the further user activity 558 to the behavior profile 448. Based on the comparison, the anomalous action detector 550 can determine whether the further user activity 558 is consistent with the behavior profile 448.

The further user activity 558 can include an activity, similar to the activity 228, that was logged after the generation of the behavior profile 448. The further user activity 558 can be mapped to a predicate group 342, subject group 344 pair, such as by the anomalous action detector 550 or operation 446 (see FIG. 4).

The anomalous action detector 550 can apply a heuristic or machine learning technique to the behavior profile 448 and further user activity 558 to determine whether they are consistent with each other. For example, a collaborative filtering technique can be implemented by the anomalous action detector 550 to identify whether the further user activity 558 is consistent with the behavior profile 448. In another example, a neural network (NN) can he trained to receive the behavior profile 448 and the further user activity 558 and provide a likelihood that the further user activity 558 is consistent (or inconsistent) with the behavior profile. Training the NN can include providing example behavior profiles and further user activity 558 along with a corresponding classification in the form of feedback/alert 552.

The feedback/alert 552 can he provided to the client 114 (see FIG. 1) responsive to detection of inconsistent behavior or something that might be inconsistent behavior. The feedback/alert 552 can include a pop-up window, text message, email, or the like. The feedback/alert 552 can include information that lead to production of the feedback/alert 552 or a link that, when selected, navigates a user to the information that lead to production of the feedback/alert 552.

Note that a reference number with a letter suffix represents a specific instance of an item while the same reference number without the letter suffix represents the item generally. For example, the predicate group 342A is a specific instance of the general predicate group 342.

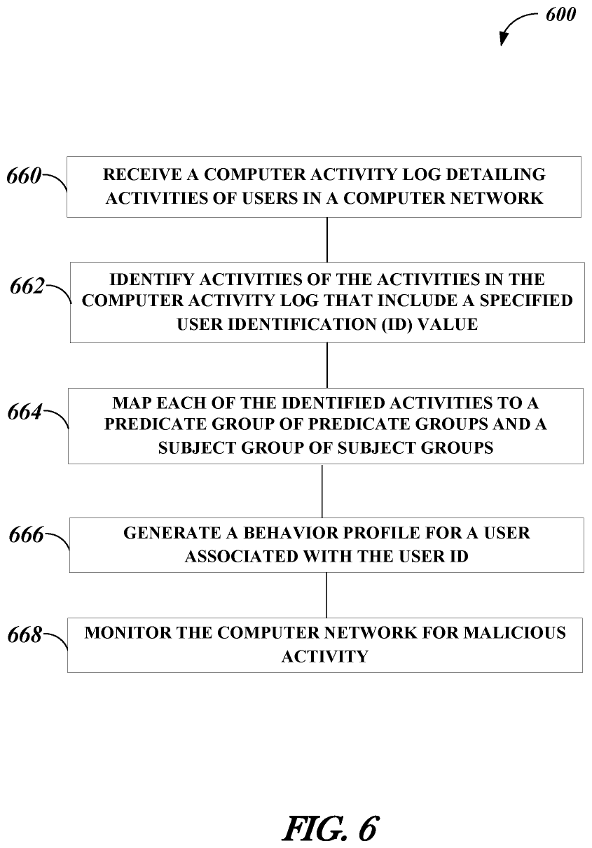

FIG. 6 illustrates, by way of example, a block diagram of an embodiment of a method 600 for compute resource security management. The method 600 as illustrated includes receiving a computer activity log detailing activities of users in a computer network, at operation 660; identifying activities of the activities in the computer activity log that include a specified user identification (ID) value, at operation 662; mapping each of the identified activities to a predicate group of predicate groups and a subject group of subject groups, at operation 664; generating a behavior profile for a user associated with the user ID, at operation 666; and monitoring the computer network for malicious activity, at operation 668. The computer activity log can include one or more of a resource management log or a resource operation log. The behavior profile can include, for each activity the predicate group and the subject group to which the activity mapped in place of a description and action of the activity. The operation 668 can be performed based on the generated behavior profile.

The method 600 can further include receiving a second computer activity log detailing further user activity of the user associated with the specified user ID value in the computer network. The method 600 can further include mapping the further user activity to a same or different predicate group and a same or different subject group. The method 600 can further include, based on the same or different predicate group and subject group, determining whether the further user activity is consistent with the generated behavior profile. The method 600 can further include providing an alert responsive to determining the further user activity is not consistent with the generated behavior profile.

The method 600 can further include, wherein mapping the further user activity to a same or different predicate group and subject group includes determining a similarity between tokens and words of the further user activity and predicate seed words associated with each predicate group, respectively and associating the further user activity with the predicate group determined to be most similar to the further user activity. The method 600 can further include, wherein mapping the further user activity to a same or different predicate group and subject group includes determining a similarity between tokens and words of the further user activity and the seed words associated with each subject group, respectively and associating the further user activity with the subject group determined to be most similar to the further user activity.

The method 600 can further include associating, with each of the predicate groups, predicate seed words. The method 600 can further include projecting the predicate seed words, respectively, and tokens and words of activities, respectively, to an embedding space. The method 600 can further include associating a token of the tokens with a predicate group of the predicate groups if the token is within a specified distance of a predicate seed word associated with the predicate group resulting in an expanded word set for the predicate group. The method 600 can further include associating, with each of the subject groups, subject seed words. The method 600 can further include projecting the subject seed words, respectively, to the embedding space. The method 600 can further include associating a token of the tokens with a subject group of the subject groups if the token is within a specified distance of a subject seed word associated with the subject group, resulting in an expanded word set for the subject group. The method 600 can further include, wherein mapping each of the identified activities to a predicate group of predicate groups and a subject group of subject groups is performed based on the expanded word set for the subject group and the expanded word set for the predicate group.

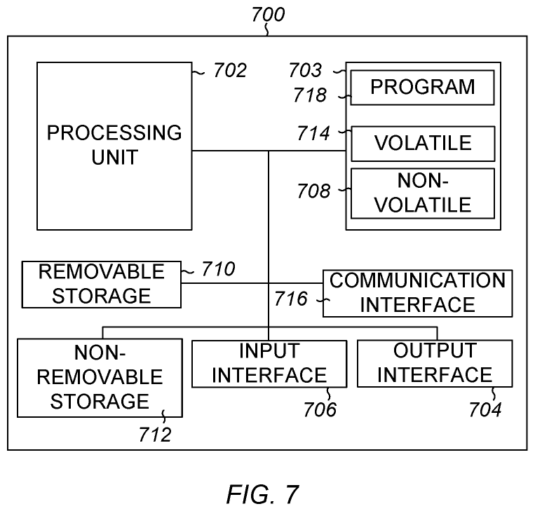

FIG. 7 illustrates, by way of example, a block diagram of an. embodiment of a machine 700 (e.g., a computer system) to implement one or more embodiments. The machine 700 can implement a technique for improved cloud resource security. The client 114, network 112, compute resources 124, monitor 126, 128, lemmatizer 331A, 331B, natural language processor 336A, 336B, operations 440, 446, anomalous behavior detector 550, or a component thereof can include one or more of the components of the machine 700. One or more of the client 114, network 112, compute resources 124, monitor 126, 128, lemmatizer 331A, 331B, natural language processor 336A, 336B, operations 440, 446, anomalous behavior detector 550, method 600, or a component or operations thereof can be implemented, at least in part, using a component of the machine 700. One example machine 700 (in the form of a computer), may include a processing unit 702, memory 703, removable storage 710, and non-removable storage 712. Although the example computing device is illustrated and described as machine 700, the computing device may be in different forms in different embodiments. For example, the computing device may instead be a smartphone, a tablet, smartwatch, or other computing device including the same or similar elements as illustrated and described regarding FIG. 7. Devices such as smartphones, tablets, and smartwatches are generally collectively referred to as mobile devices. Further, although the various data storage elements are illustrated as part of the machine 700, the storage may also or alternatively include cloud-based storage accessible via a network, such as the Internet.

Memory 703 may include volatile memory 714 and non-volatile memory 708. The machine 700 may include or have access to a computing environment that includes a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 700 may include or have access to a computing environment that includes input 706, output 704, and a communication connection 716. Output 704 may include a display device, such as a touchscreen, that also may serve as an input device. The input 706 may include one or more of a touchscreen, touchpad, mouse, keyboard, camera, one or more device-specific buttons, one or more sensors integrated within or coupled via wired or wireless data connections to the machine 700, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 702 (sometimes called processing circuitry) of the machine 700. A hard drive, CD-ROM, and RAM are some examples of articles including a non-transitory computer-readable medium such as a storage device. For example, a computer program 718 may be used to cause processing unit 702 to perform one or more methods or algorithms described herein.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like).

Additional Notes and Examples

Example 1 can include a computer security event detection method comprising receiving a computer activity log detailing activities of users in a computer network, the computer activity log including one or more of a resource management log or a resource operation log, identifying activities of the activities in the computer activity log that include a specified user identification (ID) value, mapping each of the identified activities to a predicate group of predicate groups and a subject group of subject groups, generating a behavior profile for a user associated with the user IIS, the behavior profile including, for each activity the predicate group and the subject group to which the activity mapped in place of a description and action of the activity, and based on the generated behavior profile, monitoring the computer network for malicious activity.

in Example 2, Example 1 can further include, receiving a second computer activity log detailing further user activity of the user associated with the specified user ID value in the computer network, mapping the further user activity to a same or different predicate group and a same or different subject group, based on the same or different predicate group and subject group, determining whether the further user activity is consistent with the generated behavior profile, and providing an alert responsive to determining the further user activity is not consistent with the generated behavior profile.

In Example 3, Example 2 can further include, wherein mapping the further user activity to a same or different. predicate group and subject group includes determining a similarity between tokens and words of the further user activity and predicate seed words associated with each predicate group, respectively, and associating the further user activity with the predicate group determined to be most similar to the further user activity.

In Example 4, Example 3 can further include, wherein mapping the further user activity to a same or different predicate group and subject group includes determining a similarity between tokens and words of the further user activity and the seed words associated with each subject group, respectively, and associating the further user activity with the subject group determined to be most similar to the further user activity.

In Example 5, at least one of Examples 1-4 can further include associating, with each of the predicate groups, predicate seed words, projecting the predicate seed words, respectively, and tokens and words of activities, respectively, to an embedding space, and associating a token of the tokens with a predicate group of the predicate groups if the token is within a specified distance of a predicate seed word associated with the predicate group resulting in an expanded word set for the predicate group.

In Example 6, Example 5 can further include associating, with each of the subject groups, subject seed words, projecting the subject seed words, respectively, to the embedding space, and associating a token of the tokens with a subject group of the subject groups if the token is within a specified distance of a subject seed word associated with the subject group, resulting in an expanded word set for the subject group.

In Example 7, Example 6 can further include, wherein mapping each of the identified activities to a predicate group of predicate groups and a subject group of subject groups is performed based on the expanded word set for the subject group and the expanded word set for the predicate group.

Example 8 can include a device for performing the method of at least one of Examples 1-7.

Example 9 can include a non-transitory machine-readable medium including instructions that, when executed by a machine, cause the machine to perform operations comprising the method of at least one of Examples 1-7.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A computer security event detection method comprising:
receiving a computer activity log detailing activities of users in a computer network, the computer activity log including one or more of a resource management log or a. resource operation log;
identifying activities of the activities in the computer activity log that include a specified user identification (ID) value;
mapping each of the identified activities to a predicate group of predicate groups and a subject group of subject groups;
generating a behavior profile for a user associated with the user II), the behavior profile including, for each activity the predicate group and the subject group to which the activity mapped in place of a description and action of the activity; and
based on the generated behavior profile, monitoring the computer network for malicious activity.

2. The method of claim 1, further comprising:
receiving a second computer activity log detailing further user activity of the user associated with the specified user ID value in the computer network;
mapping the further user activity to a same or different predicate group and a same or different subject group;
based on the same or different predicate group and subject group, determining whether the further user activity is consistent with the generated behavior profile; and
providing an alert responsive to determining the further user activity is not consistent with the generated behavior profile.

3. The method of claim 2, wherein mapping the further user activity to a same or different predicate group and subject group includes:
determining a similarity between tokens and words of the further user activity and predicate seed words associated with each predicate group, respectively; and
associating the further user activity with the predicate group determined to be most similar to the further user activity.

4. The method of claim 3, wherein mapping the further user activity to a same or different predicate group and subject group includes:
determining a similarity between tokens and words of the further user activity and the seed words associated with each subject group, respectively; and
associating the further user activity with the subject group determined to be most similar to the further user activity. The method of claim 1 further comprising:
associating, with each of the predicate groups, predicate seed words;
projecting the predicate seed words, respectively, and tokens and words of activities, respectively, to an embedding space; and
associating a token of the tokens with a predicate group of the predicate groups if the token is within a specified distance of a predicate seed word associated with the predicate group resulting in an expanded word set for the predicate group.

6. The method of claim 5, further comprising:
associating, with each of the subject groups, subject seed words;
projecting the subject seed words, respectively, to the embedding space; and
associating a token of the tokens with a subject group of the subject groups if the token is within a specified distance of a subject seed word associated with the subject group, resulting in an expanded word set for the subject group.

7. The method of claim 6, wherein mapping each of the identified activities to a predicate group of predicate groups and a subject group of subject groups is performed based on the expanded word set for the subject group and the expanded word set for the predicate group.

8. A compute device comprising:
processing circuitry;
a memory coupled to the processing circuitry, the memory including instructions that, when executed by the processing circuitry, cause the processing circuitry to perform operations for cyber security event detection, the operations comprising:
receiving a computer activity log detailing activities of users in a computer network, the computer activity log including one or more of a resource management log or a resource operation log;
identifying activities of the activities in the computer activity log that include a specified user identification (ID) value;
mapping each of the identified activities to a predicate group of predicate groups and a subject group of subject groups;
generating a behavior profile for a user associated with the user ID, the behavior profile including, for each activity the predicate group and the subject) group to which the activity mapped in place of a description and action of the activity; and
based on the generated behavior profile, monitoring the computer network for malicious activity,

9. The device of claim 8, wherein the operations further comprise:
receiving a second computer activity log detailing further user activity of the user associated with the specified user ID value in the computer network;
mapping the further user activity to a same or different predicate group and a same or different subject group;
based on the same or different predicate group and subject: group, determining whether the further user activity is consistent with the generated behavior profile; and
providing an alert responsive to determining the further user activity is not consistent with the generated behavior profile.

10. The device of claim 9, wherein mapping the further user activity to a same or different predicate group and subject group includes:
determining a similarity between tokens and words of the further user activity and predicate seed words associated with each predicate group, respectively; and
associating the further user activity with the predicate group determined to be most similar to the further user activity.

11. The device of claim 10, wherein mapping the further user activity to a same or different predicate group and subject group includes:
determining a similarity between tokens and words of the further user activity and the seed words associated with each subject group, respectively; and
associating the further user activity with the subject group determined to be most similar to the further user activity.

12. The device of claim 8, wherein the operations further comprise:
associating, with each of the predicate groups, predicate seed words;
projecting the predicate seed words, respectively, and tokens and words of activities, respectively, to an embedding space; and
associating a token of the tokens with a predicate group of the predicate groups if the token is within a specified distance of a predicate seed word associated with the predicate group resulting in an expanded word set for the predicate group.

13. The device of claim 12, wherein the operations further comprise:
associating, with each of the subject groups, subject seed words;
projecting the subject seed words, respectively, to the embedding space; and
associating a token of the tokens with a subject group of the subject groups if the token is within a specified distance of a subject seed word associated with the subject group, resulting in an expanded word set for the subject group.

14. The device of claim 13, wherein mapping each of the identified activities to a predicate group of predicate groups and a subject group of subject groups is performed based on the expanded word set for the subject group and the expanded word set for the predicate group.

15. A non-transitory machine-readable medium including instructions that, when executed by a machine, cause the machine to perform operations for cyber security event detection, the operations comprising:
receiving a computer activity log detailing activities of users in a computer network, the computer activity log including one or more of a resource management log or a. resource operation log;
identifying activities of the activities in the computer activity log that include a specified user identification (ID) value;
mapping each of the identified activities to a predicate group of predicate groups and a subject group of subject groups;
generating a behavior profile for a user associated with the user ID, the behavior profile including, for each activity the predicate group and the subject group to which the activity mapped in place of a description and action of the activity; and
based on the generated behavior profile, monitoring the computer network for malicious activity.

16. The non-transitory machine-readable medium of claim 15, wherein the operations further comprise:
receiving a second computer activity log detailing further user activity of the user associated with the specified user ID value in the computer network;
mapping the further user activity to a same or different predicate group and a same or different subject group;
based on the same or different predicate group and subject group, determining whether the further user activity is consistent with the generated. behavior profile; and
providing an alert responsive to determining the further user activity is not consistent with the generated behavior profile.

17. The non-transitory machine-readable medium of claim 16, wherein mapping the further user activity to a same or different predicate group and subject group includes:
determining a similarity between tokens and words of the further user activity and predicate seed words associated with each predicate group, respectively; and
associating the further user activity with the predicate group determined to be most similar to the further user activity.

18. The non-transitory machine-readable medium of claim 17, wherein mapping the further user activity to a same or different predicate group and subject group includes:
determining a similarity between tokens and words of the further user activity and the seed words associated with each subject group, respectively; and
associating the further user activity with the subject group determined to be most similar to the further user activity.

19. The non-transitory machine-readable medium of claim 15, wherein the operations further comprise:
associating, with each of the predicate groups, predicate seed words;
projecting the predicate seed words, respectively, and tokens and words of activities, respectively, to an embedding space; and
associating a token of the tokens with a predicate group of the predicate groups if the token is within a specified distance of a predicate seed word associated with the predicate group resulting in an expanded word set for the predicate group.

20. The non-transitory machine-readable medium of claim 12, wherein the operations further comprise:
associating, with each of the subject groups, subject seed words;
projecting the subject seed words, respectively, to the embedding space; and
associating a token of the tokens with a subject group of the subject groups if the token is within a specified distance of a subject seed word associated with the subject group, resulting in an expanded word set for the subject group; and
wherein mapping each of the identified activities to a predicate group of predicate groups and a subject group of subject groups is performed based on the expanded word set for the subject group and the expanded word set for the predicate group.
